(19) United States
(12) Patent Application Publication
(10) Pub. No.: US 2006/0077809 A1
(43) Pub. Date: Apr. 13, 2006

(54) Optical pickup and disc drive apparatus

(75) Inventors: Shinya Makita, Kanagawa (JP); Katsutoshi Sato, Tokyo (JP); Noriyuki Mori, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/221,748

(22) Filed: Sep. 9, 2005

(30) Foreign Application Priority Data
Sep. 13, 2004 (JP) 2004-265381
Nov. 5, 2004 (JP) 2004-322338

(51) Int. Cl. G11B 7/00

(52) U.S. Cl. 369/44.37; 369/112.01; 369/44.14

(57) ABSTRACT

An objective lens actuator has a fixed block fixedly mounted on a movable base and a movable block movable with respect to the fixed block in focusing directions toward and away from recording surfaces of the disc-shaped recording mediums and tracking directions which are substantially radial directions of the disc-shaped recording mediums. A first objective lens is mounted on the movable block for focusing a first laser beam onto the recording surface of a digital versatile disc or a compact disc. A second objective lens is mounted on the movable block for focusing a second laser beam, which has a wavelength shorter than the first laser beam, onto the recording surface of a Blu-ray Disc. The first objective lens and the second objective lens are spaced from each in a tangential direction of recording tracks on the disc which is perpendicular to the focusing directions and the tracking directions. The first or second objective lens has a center positioned on a line which passes through the center of the disc and which extends in the radial directions of the disc. The first objective lens has a center positioned on a line which passes through the center of the second objective lens and which extends in the tangential direction.

### CROSS REFERENCES TO RELATED APPLICATIONS

The present invention contains subject matter related to Japanese Patent Application JP 2004-265381 filed in the Japanese Patent Office on Sep. 13, 2004, and Japanese Patent Application JP 2004-322338 filed in the Japanese Patent Office on Nov. 5, 2004, the entire contents of which being incorporated herein by reference.

### BACKGROUND OF THE INVENTION

The present invention relates to an optical pickup and a disc drive apparatus and more particularly to an optical pickup having an objective lens actuator which holds two objective lenses and a disc drive apparatus incorporating such an optical pickup for playing back a plurality of discs of different types.

Disc drive apparatuses record an information signal on and reproduce an information signal from disc-shaped recording mediums such as optical discs, magnetooptical discs, etc. Such disc drive apparatuses have an optical pickup movable radially across the disc-shaped recording medium for applying a laser beam to the disc-shaped recording medium.

The optical pickup has an objective lens actuator for actuating an objective lens that is held on a movable block. The objective lens actuator moves the objective lens in focusing directions toward and away from the recording surface of the disc-shaped recording medium for focusing adjustment. The objective lens actuator also moves the objective lens in tracking directions, which are substantially the same as radial directions of the disc-shaped recording medium, for tracking adjustment. When the objective lens is thus controlled by the objective lens actuator, the laser beam that is applied through the objective lens to the disc-shaped recording medium is focused onto and traces the recording tracks on the disc-shaped recording medium.

In recent years, there have been developed various types of disc-shaped recording mediums having different recording densities and cover thicknesses. These different types of disc-shaped recording mediums include, for example, a compact disc (CD) playable with a laser beam having a wavelength of about 780 nm, a digital versatile disc (DVD) playable with a laser beam having a wavelength of about 660 nm, and a Blu-ray disc (BD) playable with a laser beam having a wavelength of about 405 nm.

One optical pickup for recording an information signal on and reproducing an information signal from a plurality of disc-shaped recording mediums of different types that are playable with laser beams having different wavelengths has two objective lenses for use with such different disc-shaped recording mediums as disclosed, for example, in Japanese Patent Laid-Open No. Hei 9-35304 (hereinafter referred to as Patent Document 1).

The optical pickup in Patent Document 1, laser beams having different wavelengths are focused by the two objective lenses onto the recording surfaces of respective disc-shaped recording mediums to record information signals on and reproduce information signals from the disc-shaped recording mediums.

The two objective lenses are mounted on a movable block at respective positions that are spaced from each other in a tangential direction of recording tracks on the disc-shaped recording mediums which is perpendicular to the radial direction of the disc-shaped recording mediums, i.e., the direction in which the optical pickup moves radially across the disc-shaped recording mediums. Since the two objective lenses are spaced away from each other in the tangential direction, the movable block is well balanced in the radial direction of the disc-shaped recording mediums for maximizing the characteristics of the objective lens actuator.

Disc-shaped recording mediums of certain types have innermost recording tracks Tp at different positions. Therefore, it is desirable to design optical pickups in view of such differently positioned innermost recording tracks Tp.

In the past, some conventional optical disc drives are capable of recording information signals on and reproducing information signals from optical discs of two different types, i.e., a CD and a DVD.

Optical disc drives compatible with both CDs and DVDs can be reduced in size if an optical path made up of an objective lens, a collimator lens, etc. is shared by a CD laser beam and a DVD laser beam as disclosed, for example, in Japanese Patent Laid-Open No. 2002-298869 (hereinafter referred to as Patent Document 2).

Blu-ray discs (registered trademark) playable with a blue-purple laser beam having a wavelength of 405 nm have been put to use in recent years. Since the Blu-ray discs (BDs) are played with a laser beam whose wavelength is much shorter than laser beams for playing optical discs in the past, the BDs have a recording capacity that is several times greater than DVDs of the same diameter. Three-wavelength optical disc drives which are capable of playing CDs, DVDs, and BDs have also been put to use in recent years.

However, inasmuch as the wavelength of the laser beam for playing BDs is 405 nm and is widely different from the wavelengths of the laser beams for playing CDs and DVDs, it is difficult to design an objective lens that is compatible with those three wavelengths. Therefore, it is practical for three-wavelength optical disc drives to have an optical pickup incorporating two objective lenses, one for BDs and one for CDs and DVDs.

If an optical path for a laser beam for playing BDs and an optical path for laser beams for playing CDs and DVDs are completely separate from each other, then the three-wavelength optical disc drive can be designed with ease. However, the optical pickup becomes unduly large in size. One solution is to support two objective lenses, one for BDs and one for CDs and DVDS, on a single biaxial actuator in a three-wavelength optical pickup for applying laser beams supplied from respective optical paths, one for BDs and one for CDs and DVDs, to the respective objective lenses.

The three-wavelength optical pickup thus constructed requires two mirrors, one for BDs and one for CDs and DVDs, for applying the laser beams to the respective objective lenses. The biaxial actuator is of such a complex structure including a lens support mechanism, actuating coils, etc. that the laser beams are applied in a limited range to the biaxial actuator. In particular, an optical disc drive of a low profile, or a so-called slim drive, for use in a notebook personal computer has a limited thickness which poses limitations on the range in which the laser beams are applied to the biaxial actuator, making it difficult to make the optical pickup itself lower in profile.

It is an object of the present invention to provide an optical pickup which will solve the above problems, can be designed with ease, can be moved efficiently, is compatible with a plurality of wavelengths, is lower in profile, and is smaller in size, and an optical disc drive apparatus which incorporates such as optical pickup.

### SUMMARY OF THE INVENTION

According to the present invention, each of an optical pickup and a disc drive apparatus has an objective lens actuator. The objective lens actuator has a fixed block fixedly mounted on a movable base and a movable block movable with respect to the fixed block in focusing directions toward and away from recording surfaces of the disc-shaped recording mediums and tracking directions which are substantially radial directions of the disc-shaped recording mediums. A first objective lens is mounted on the movable block for focusing a first laser beam onto the recording surface of one of the disc-shaped recording mediums. A second objective lens is mounted on the movable block for focusing a second laser beam, which has a wavelength shorter than the first laser beam, onto the recording surface of another one of the disc-shaped recording mediums which is different in type from the one of the disc-shaped recording mediums. The first objective lens and the second objective lens are spaced from each in a tangential direction of recording tracks on the disc-shaped recording mediums which is perpendicular to the focusing directions and the tracking directions. The first or second objective lens has a center positioned on a line which passes through the center of the disc-shaped recording mediums selectively mounted on the disc table and which extends in the radial directions of the disc-shaped recording mediums. The first objective lens has a center positioned on a line which passes through the center of the second objective lens and which extends in the tangential direction.

With the above arrangement, the movement of the optical pickup toward a spindle motor which rotates the disc table is minimized.

The optical pickup further includes a first laser beam source for emitting the first laser beam, a second laser beam source for emitting the second laser beam, a first optical path for guiding the first laser beam from the first laser beam source to the first objective lens, a second optical path for guiding the second laser beam from the second laser beam source to the second objective lens, an optical path combiner for combining portions of the first optical path and the second optical path, and an optical path separator for separating the portions of the first optical path and the second optical path which have been combined by the optical path combiner, in front of the first objective lens and the second objective lens.

The first objective lens and the second objective lens are mounted on the objective lens actuator, which serves as a biaxial actuator, and the optical path combiner combines the portions of the first optical path and the second optical path before the first laser beam and the second laser beam are introduced into the objective lens actuator.

Since the first optical path and the second optical path are combined with each other before the objective lens actuator, and separated from each other before the first and second objective lenses, the optical pickup which is low in profile and compatible with a plurality of wavelengths may be constructed using the objective lens actuator which is low in profile and has a limited range in which the laser beams are introduced.

Specifically, there is provided in accordance with the present invention an optical pickup for selectively applying at least two laser beams having respective wavelengths to one of at least two disc-shaped recording mediums of different types selectively mounted on a disc table, including a movable base movable radially across the disc-shaped recording mediums selectively mounted on the disc table, and an objective lens actuator mounted on the movable base, the objective lens actuator including a fixed block fixedly mounted on the movable base, a movable block movable with respect to the fixed block in focusing directions toward and away from recording surfaces of the disc-shaped recording mediums and tracking directions which are substantially radial directions of the disc-shaped recording mediums, a first objective lens mounted on the movable block for focusing a first laser beam onto the recording surface of one of the disc-shaped recording mediums, and a second objective lens mounted on the movable block for focusing a second laser beam, which has a wavelength shorter than the first laser beam, onto the recording surface of another one of the disc-shaped recording mediums which is different in type from the one of the disc-shaped recording mediums, the first objective lens and the second objective lens being spaced from each in a tangential direction of recording tracks on the disc-shaped recording mediums which is perpendicular to the focusing directions and the tracking directions, the first or second objective lens having a center positioned on a line which passes through the center of the disc-shaped recording mediums selectively mounted on the disc table and which extends in the radial directions of the disc-shaped recording mediums, the first objective lens having a center positioned on a line which passes through the center of the second objective lens and which extends in the tangential direction.

In the above optical pickup, the end of the stroke of the movement of the optical pickup closer to the disc table may be set to a position that is spaced maximally from the spindle motor. The optical pickup can be designed with ease for keeping the movable base and the spindle motor out of contact with each other. The optical pickup can thus be designed easily and manufactured at a reduced cost.

The distance that the optical pickup moves toward the disc table can be minimized, thereby making the optical pickup efficient in terms of its movement.

There is also provided in accordance with the present invention a disc drive apparatus for selectively playing at least two disc-shaped recording mediums of different types, including a disc table for selectively mounting the disc-shaped recording mediums thereon, and an optical pickup for selectively applying at least two laser beams having respective wavelengths to one of the disc-shaped recording mediums selectively mounted on the disc table, the optical pickup including a movable base movable radially across the disc-shaped recording mediums selectively mounted on the disc table, and an objective lens actuator mounted on the movable base, the objective lens actuator including a fixed block fixedly mounted on the movable base, a movable block movable with respect to the fixed block in focusing directions toward and away from recording surfaces of the disc-shaped recording mediums and tracking directions which are substantially radial directions of the disc-shaped recording mediums, a first objective lens mounted on the movable block for focusing a first laser beam onto the recording surface of one of the disc-shaped recording mediums, and a second objective lens mounted on the movable block for focusing a second laser beam, which has a wavelength shorter than the first laser beam, onto the recording surface of another one of the disc-shaped recording mediums which is different in type from the one of the disc-shaped recording mediums, the first objective lens and the second objective lens being spaced from each in a tangential direction of recording tracks on the disc-shaped recording mediums which is perpendicular to the focusing directions and the tracking directions, the first or second objective lens having a center positioned on a line which passes through the center of the disc-shaped recording mediums selectively mounted on the disc table and which extends in the radial directions of the disc-shaped recording mediums, the first objective lens having a center positioned on a line which passes through the center of the second objective lens and which extends in the tangential direction.

In the above disc drive apparatus, the end of the stroke of the movement of the optical pickup closer to the disc table may be set to a position that is spaced maximally from the spindle motor. The disc drive apparatus can be designed with ease for keeping the movable base and the spindle motor out of contact with each other. The disc drive apparatus can thus be designed easily and manufactured at a reduced cost.

The distance that the optical pickup moves toward the disc table can be minimized, thereby making the optical pickup efficient in terms of its movement.

The first optical path and the second optical path are combined with each other before the objective lens actuator, and separated from each other before the first and second objective lenses. Consequently, the optical pickup which is low in profile and compatible with a plurality of wavelengths may be constructed using the objective lens actuator which is low in profile and has a limited range in which the laser beams are introduced. Therefore, the optical pickup and the disc drive apparatus are made compatible with a plurality of wavelengths and low in profile.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic perspective view of a disc drive apparatus according to an embodiment of the present invention;

FIG. 2 is an enlarged plan view of an objective lens actuator of the disc drive;

FIG. 3 is an enlarged cross-sectional view of a portion of the objective lens actuator;

FIG. 4 is a fragmentary plan view showing the positional relationship between two objective lenses and recording tracks on a disc-shaped recording medium;

FIG. 5 is an enlarged fragmentary plan view illustrative of the positional relationship shown in FIG. 4;

FIG. 6 is a fragmentary plan view of an objective lens actuator with two objective lenses in different positions;

FIG. 7 is a fragmentary plan view illustrating the problems of a optical pickup in the past; and

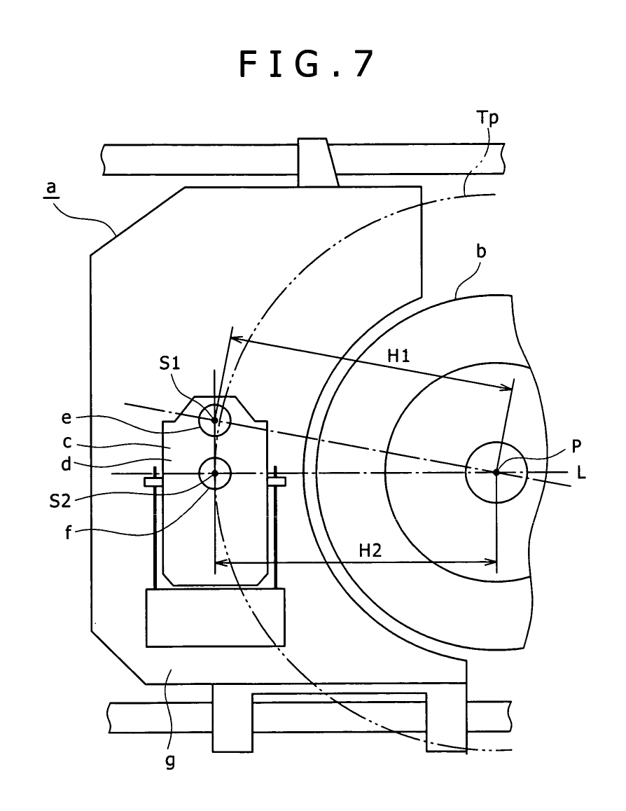

FIGS. 8A and 8B are views showing an arrangement of an optical pickup according to the present invention.

### DETAILED DESCRIPTION OF THE PREFERRED EMBODIMENTS

The best mode of an optical pickup and a disc drive apparatus according to the present invention will hereinafter be described with reference to the drawings.

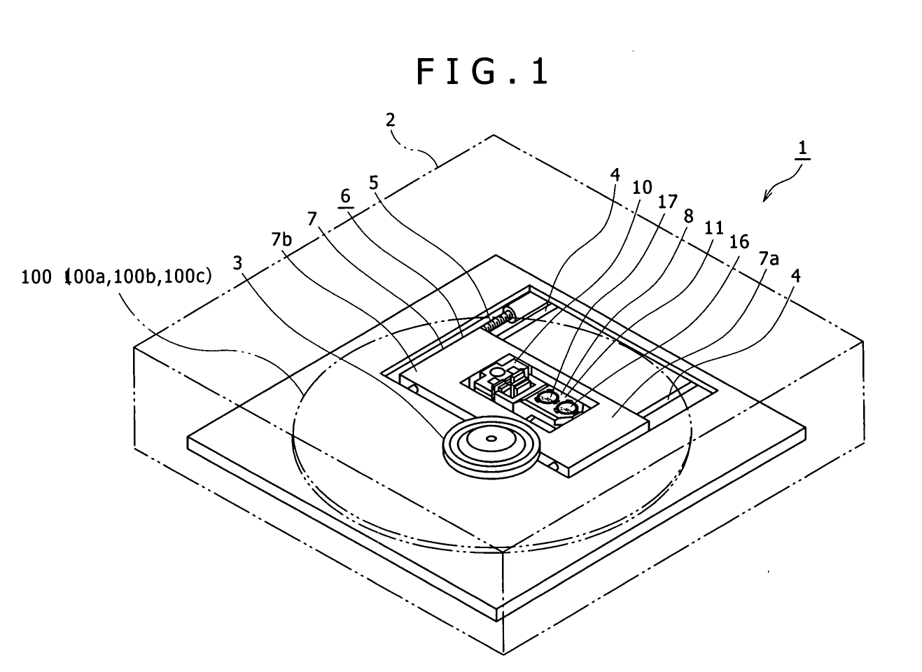

As shown in FIG. 1, a disc drive apparatus 1 according to the present invention has an outer housing 2 which houses therein various components and mechanisms. The outer housing 2 has a disc insertion slot (not shown) defined in a side wall thereof.

A chassis (not shown) is disposed in the outer housing 2, and a disc table 3 is fixed to the motor shaft of a spindle motor mounted on the chassis.

Two parallel guide shafts 4 are mounted on the chassis. A lead screw 5 that is rotatable by a feed motor (not shown) is supported on the chassis.

An optical pickup 6 according to the present invention has a movable base 7, optical parts mounted on the movable base 7, and an objective lens actuator 8 mounted on the movable base 7. The movable base 7 has bearings 7a, 7b on its opposite ends which are slidably supported by the respective guide shafts 4.

A nut (not shown) mounted on the movable base 7 is threaded over the lead screw 5. When the lead screw 5 is rotated about its own axis by the feed motor, the nut is displaced along the lead screw 5 in a direction depending on the direction in which the lead screw 5 is rotated, moving the optical pickup 6 radially across a disc-shaped recording medium 100 that is mounted on the disc table 3.

The disc-shaped recording medium 100 may be either a digital versatile disc (DVD) 100a, a compact disc (CD) 100b, or a Blu-ray disc (BD) 100c. A laser beam that is used to play the DVD 100a has a wavelength of about 660 nm. A laser beam that is used to play the CD 100b has a wavelength of about 780 nm. A laser beam that is used to play the BD 100c has a wavelength of about 405 nm.

The disc-shaped recording medium 100 generally has a first write area referred to as an information area where information representing images, music, characters, etc. is written, and a second write area referred to as a burst cutting area or a transition area where various medium information representing the type of the disc-shaped recording medium 100, configurations thereof, etc. is written. The second write area is formed radially inwardly of the first write area, and is positioned in a radially innermost region of the disc-shaped recording medium 100.

An innermost recording track in the second write area is positioned differently depending on the type of the disc-shaped recording medium 100. It is known that the innermost recording track in the second write area of the DVD 100a or the CD 100b is positioned about 22 mm from the center of the disc, and the innermost recording track in the second write area of the BD 100c is positioned about 21 mm from the center of the disc.

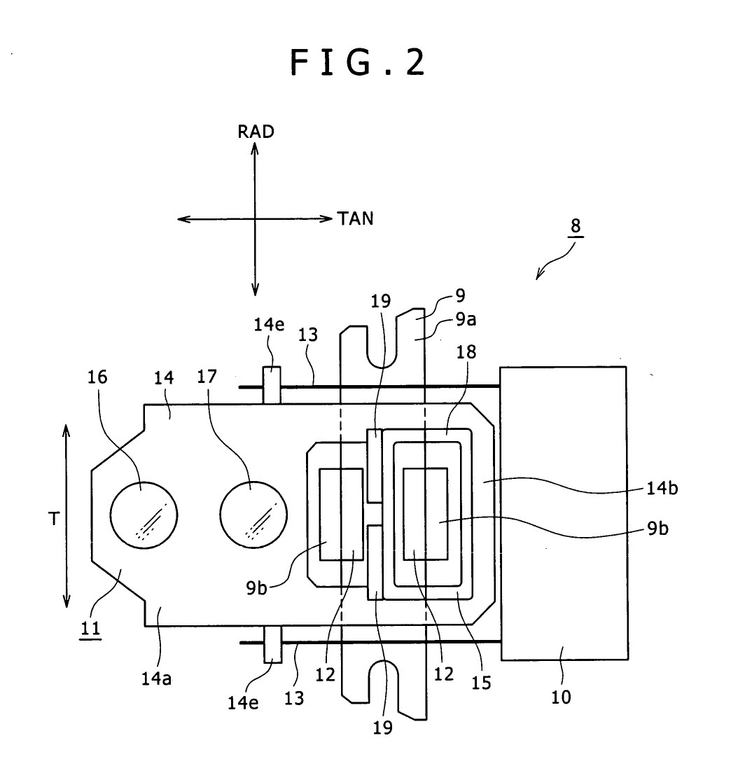

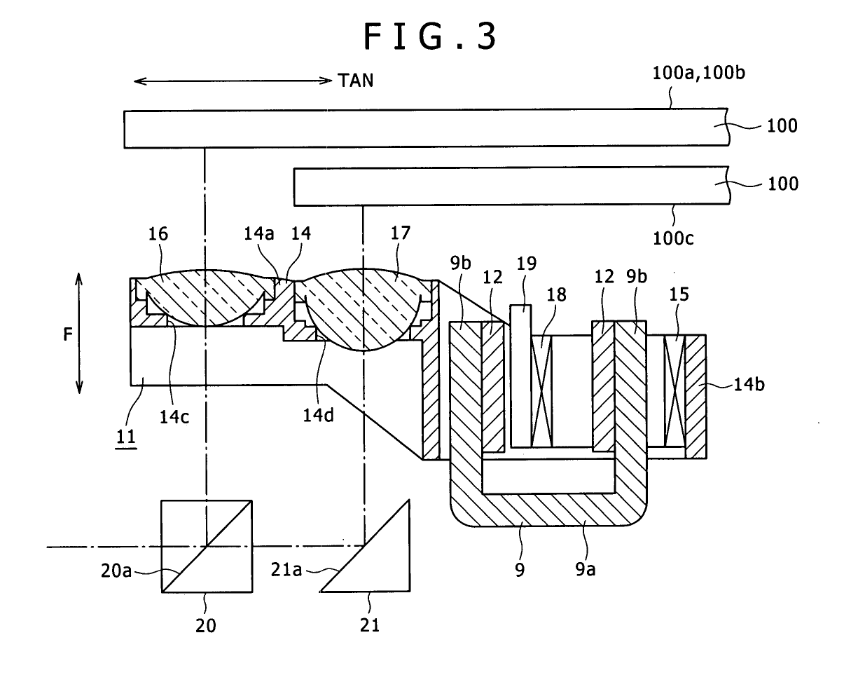

When the disc drive apparatus 1 records an information signal on or reproduces an information signal from the disc-shaped recording medium 100, the optical pickup 6 first reads information recorded in the second write area, and then writes information in the first write area or reads information recorded in the first write area. Therefore, when the disc drive 1 records an information signal on or reproduces an information signal from the DVD 100a or the CD 100b, the optical pickup 6 first reads information from the recording track that is positioned about 22 mm from the center of the disc, and when the disc drive apparatus 1 records an information signal on or reproduces an information signal from the BD 100c, the optical pickup 6 first reads information from the recording track that is positioned about 21 mm from the center of the disc, As shown in FIGS. 2 and 3, the objective lens actuator 8 has a base member 9, a fixed block 10, and a movable block 11 movable with respect to the fixed block 10.

The base member 9 is made of a magnetic metal material, and comprises a base 9a fixedly mounted on the movable base 7 and a pair of yokes 9b bent upwardly at a right angle from the base 9a. The yokes 9b are spaced from each other in the longitudinal direction of the objective lens actuator 8, i.e., in a tangential direction (TAN) of the recording tracks on the disc-shaped recording medium 100.

Magnets 12 are mounted respectively on surfaces of the yokes 9b which confront each other.

The fixed block 10 is fixed to the movable base 7. A circuit board (not shown) has an end attached to a rear surface of the fixed block 10 and is electrically connected to a power supply circuit (not shown).

Support springs 13 have rear ends connected to the fixed block 10 and are connected to the circuit board attached to the rear surface of the fixed block 10. The support springs 13 project forward from the fixed block 10.

The movable block 11 has a movable holder 14 and an actuator coil 15.

The movable holder 14 has a lens mount 14a and a coil holder 14b disposed behind the lens mount 14a, the lens mount 14a and the coil holder 14b being integral with each other.

The lens mount 14a has two through holes 14c, 14d (see FIG. 3) spaced from each other in the longitudinal direction of the movable holder 14. A first objective lens 16 and a second objective lens 17 are mounted on the lens mount 14a respectively over the through holes 14c, 14d.

The first objective lens 16 is arranged to pass laser beams having respective wavelengths of about 660 nm and 780 nm, and has numerical apertures of about 0.5 and 0.65 for the respective laser beams. The first objective lens 16 serves to focus the respective laser beams onto the recording surfaces of the DVD 100a and CD 100b, respectively.

The second objective lens 17 is arranged to pass a laser beam having a wavelength of about 405 nm, and has a numerical aperture of about 0.85 for the laser beam. The second objective lens 17 serves to focus the laser beam onto the recording surface of the BD 100c.

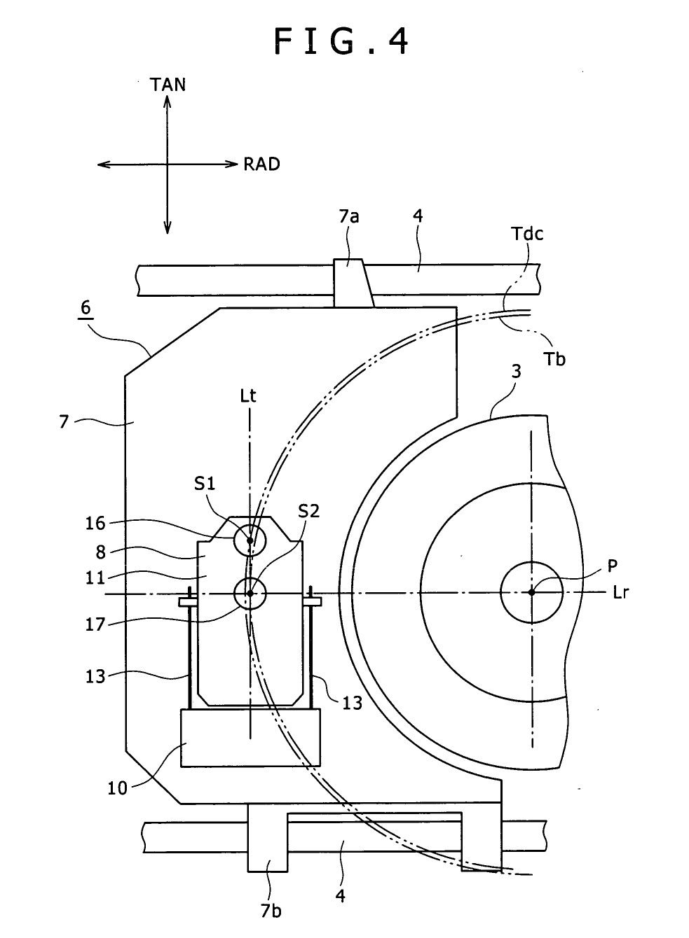

The second objective lens 17 is positioned more closely to the fixed block 10 than the first objective lens 16. As shown in FIG. 4, the second objective lens 17 has a center S2 positioned on a line Lr which extends in the direction along which the optical pickup 6 moves, i.e., in the radial direction (RAD) of the disc-shaped recording medium 100 and which passes through the center of the disc table 3, i.e., the center P of the disc-shaped recording medium 100.

The first objective lens 16 is spaced from the second objective lens 17 in the tangential direction of the recording tracks on the disc-shaped recording medium 100. The first objective lens 16 has a center S1 positioned on a line Lt which passes through the center S2 of the second objective lens 17 and which extends in the tangential direction.

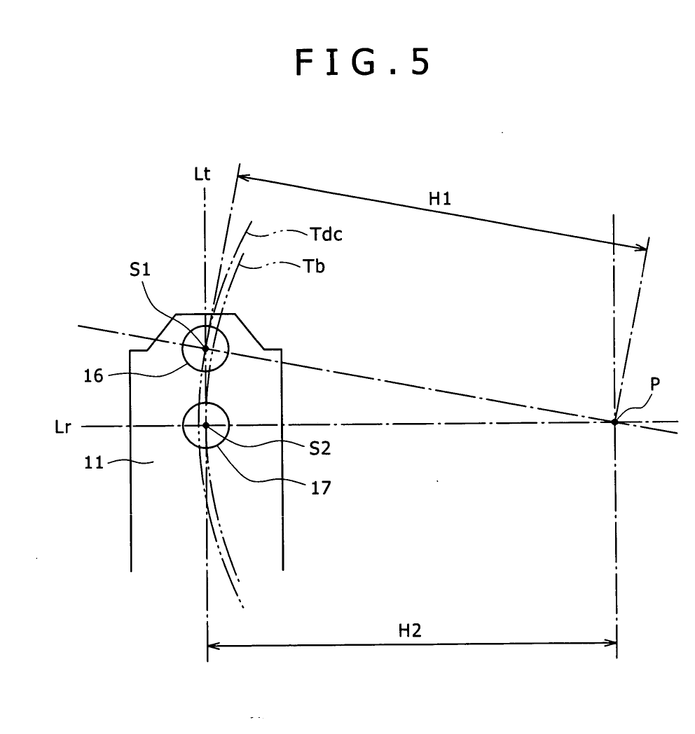

Therefore, as shown in FIG. 5, the distance H1 from the center P of the disc-shaped recording medium 100 to the center S1 of the first objective lens 16 is greater than the distance H2 from the center P of the disc-shaped recording medium 100 to the center S2 of the second objective lens 17.

As shown in FIGS. 2 and 3, the coil holder 14b of the movable block 11 is in the form of a substantially rectangular vertical frame. The actuator coil 15 is held in the coil holder 14b.

The actuator coil 15 comprises a focusing coil 18 for moving the movable block 11 in focusing directions and a pair of tracking coils 19 for moving the movable clock 11 in tracking directions. The focusing directions are directions toward and away from the disc-shaped recording medium 100, i.e., directions indicated by the arrow F in FIG. 3 or vertical directions. The tracking directions are radial directions of the disc-shaped recording medium 100, i.e., directions indicated by the arrow T in FIG. 2 or transverse directions across the objective lens actuator 8.

Each of the focusing coil 18 and the tracking coils 19 comprises a winding having a substantially rectangular tubular shape. The focusing coil 18 has a winding axis extending in the vertical directions, i.e., the focusing directions, and the tracking coils 19 have respective winding axes extending in the longitudinal directions of the objective lens actuator 8, i.e., the tangential directions. The tracking coils 19 are mounted on a front face of the focusing coil 18 and spaced from each other in the transverse directions across the objective lens actuator 8.

The focusing coil 18 and the tracking coils 19 have respective ends connected to connection terminals 14e mounted on opposite side surfaces of the movable holder 14. The support springs 13 have respective front ends connected respectively to the connection terminals 14e. Therefore, the movable block 11 is coupled to the fixed block 10 by the support springs 13, and hence is suspended in the air.

The support springs 13 are supplied with a drive current for focusing adjustment or tracking adjustment through the circuit board attached to the rear surface of the fixed block 10 from the power supply circuit. Therefore, pairs of the support springs 13 function as feeder members for supplying electric currents to the focusing coil 18 and the tracking coils 19.

The magnets 12 mounted on the respective yokes 9b are disposed in front and rear positions one on each side of the tracking coils 19.

When the focusing coil 18 or the tracking coils 19 are supplied with a drive current from the power supply circuit through the circuit board and the support springs 13, the movable block 11 moves in the focusing direction or the tracking direction depending on the direction of the drive current and the direction of magnetic fluxes generated by the magnets 12 and the yokes 9b.

When the movable block 11 moves in the focusing direction or the tracking direction, the support springs 13 are elastically deformed.

As shown in FIG. 3, a beam splitter 20 and an upwardly reflecting mirror 21 are disposed respectively below the first objective lens 16 and the second objective lens 17 which are mounted on the movable holder 14. The beam splitter 20 and the upwardly reflecting mirror 21 have a separating surface 20a and a reflecting surface 21a, respectively, which face in the same direction. The beam splitter 20 and the upwardly reflecting mirror 21 are mounted on the movable base 7. The separating surface 20a of the beam splitter 20 comprises a wavelength-dependent transmissive film whose transmittance varies dependent on the wavelength of light passing therethrough.

The disc drive 1 thus constructed operates as follows:

When the disc table 3 is rotated by the spindle motor, the disc-shaped recording medium 100 that is mounted on the disc table 3 is rotated.

If the disc-shaped recording medium 100 is the DVD 100a or the CD 100b, then a laser beam emitted from a light-emitting device (not shown) and applied to the beam splitter 20 is reflected by the separating surface 20a of the beam splitter 20, and is applied through the first objective lens 16 to the recording surface of the DVD 100a or the CD 100b. The laser beam applied the recording surface of the DVD 100a or the CD 100b is reflected thereby, and is applied as a return beam through the first objective lens 16 and the beam splitter 20 to a light-detecting device (not shown). When the return beam is applied to the light-detecting device, the light-detecting device detects signals including an RF signal, and records an information signal on or reproduces an information from the DVD 100a or the CD 100b.

If the disc-shaped recording medium 100 is the BD 100c, then a laser beam emitted from a light-emitting device (not shown) passes through the separating surface 20a of the beam splitter 20, and is reflected by the reflecting surface 21a of the upwardly reflecting mirror 21 and applied through the second objective lens 17 to the recording surface of the BD 100c. The laser beam applied the recording surface of the BD 100c is reflected thereby, and is applied as a return beam through the second objective lens 17, the upwardly reflecting mirror 21, and the beam splitter 20 to the light-detecting device. When the return beam is applied to the light-detecting device, the light-detecting device detects signals including an RF signal, and records an information signal on or reproduces an information from the BD 100c.

While in the above recording or reproducing process, when the focusing coil 18 is supplied with a drive current, the movable block 11 of the objective lens actuator 8 is moved in the focusing directions with respect to the fixed block 10 to perform focusing adjustment for focusing the spot of the laser beam emitted from the light-emitting device and applied through the first objective lens 16 or the second objective lens 17 onto the recording tracks on the disc-shaped recording medium 100.

When the tracking coils 19 are supplied with a drive current, the movable block 11 of the objective lens actuator 8 is moved in the tracking directions with respect to the fixed block 10 to perform tracking adjustment for causing the spot of the laser beam emitted from the light-emitting device and applied through the first objective lens 16 or the second objective lens 17 to trace the recording tracks on the disc-shaped recording medium 100.

While in the above recording or reproducing process, the optical pickup 6 is continuously moved radially inwardly from a radially inner area toward a radially outer area of the disc-shaped recording medium 100. If the disc-shaped recording medium 100 is the DVD 100a or the CD 100b, then the optical pickup 6 first reads recorded information from a recording track Tdc (see FIG. 4) positioned about 22 mm from the center of the disc, through the first objective lens 16. If the disc-shaped recording medium 100 is the BD 100c, then the optical pickup 6 first reads recorded information from a recording track Tb (see FIG. 4) positioned about 21 mm from the center of the disc, through the second objective lens 17.

The center S2 of the second objective lens 17 for playing the BD 100c is positioned on the line Lr which extends in the radial direction of the disc-shaped recording medium 100 and passes through the center P of the disc-shaped recording medium 100. The center S1 of the-first objective lens 16 for playing the DVD 100a or the CD 100b is positioned on the line Lt which passes through the center S2 of the second objective lens 17 and extends in the tangential direction of the recording track on the disc-shaped recording medium 100.

When the center S2 of the second objective lens 17 is positioned in alignment with the innermost recording track Tb on the BD 100c, the center S1 of the first objective lens 16 is positioned radially outwardly of the recording track Tb. If the position of the optical pickup 6 at this time is set to the end of the stroke of the radial movement thereof closer to the disc table 3, then the optical pickup 6 can read information recorded in the innermost recording track Tdc on the DVD 100a or the CD 100b.

Conversely, if an objective lens on the line Lr is used to play the DVD 100a or the CD 100b and the other objective lens is used to play the BD 100c, and also if the center of the objective lens on the line Lr which is aligned with the innermost recording track Tdc on the DVD 100a or the CD 100b is set to the end of the stroke of the radial movement thereof closer to the disc table 3, then since the center of the other objective lens is positioned radially outwardly of the innermost recording track Tb on the BD 100c at the end of the stroke, the optical pickup 6 is unable to read information recorded in the innermost recording track Tb on the BD 100c. Accordingly, a position that is radially inward of the center of the other objective lens has to be set to the end of the stroke of the radial movement thereof of the optical pickup 6 to the disc table 3. Therefore, the optical pickup 6 needs to move a large distance, and the objective lens on the line Lr is moved unnecessarily.

As described above, the first objective lens 16 for playing the DVD 100a and the CD 100b and the second objective lens 17 for playing the BD 100c are spaced from each other in the tangential direction of the recording tracks on the disc-shaped recording medium 100, and the center S2 of the second objective lens 17 is positioned on the line Lr which passes through the center P of the disc-shaped recording medium 100 and which extends in the radial direction of the disc-shaped recording medium 100. Consequently, the end of the stroke of the radial movement of the optical pickup 6 which is closer to the disc table 3 the optical pickup 6 can be set to the position that is spaced maximally from the spindle motor. The optical pickup 6 can thus be designed to keep the movable base 7 and the spindle motor out of contact with each other, and the disc drive apparatus 1 can be designed with ease and can be manufactured at a reduced cost.

The distance that the optical pickup 6 moves toward the disc table 3 can be minimized, thereby making the optical pickup 6 efficient in terms of its movement.

If the optical pickup 6 detects a tracking error signal according to the differential push-pull method, then the positional relationship between three laser beam spots on the recording surface and recording tracks thereof should preferably remain unchanged. However, since the recording tracks have different curvatures when the optical pickup 6 moves to radially inner and outer regions of the disc-shaped recording medium 100, the positional relationship between three laser beam spots and recording tracks are changed. The rate of change in the positional relationship is greater with the laser beam that is applied through the first objective lens 16 whose center S1 is not positioned on the line Lr which passes through the center P of the disc-shaped recording medium 100 and which extends in the radial direction of the disc-shaped recording medium 100, than with the laser beam that is applied through the second objective lens 17 whose center S2 is positioned on the line Lr.

If the disc-shaped recording medium 100 has a smaller track-to-track distance, i.e., a smaller track pitch, then it is more susceptible to the above positional relationship. Therefore, the BD 100c with a smaller track pitch is more susceptible to the above positional relationship than the DVD 100a and the CD 100b with greater track pitches.

According to the present invention, because the center S2 of the second objective lens 17 for playing the BD 100c is positioned on the line Lr, the accuracy with which to detect a tracking error signal according to the differential push-pull method is increased.

The optical pickup 6 mentioned above should desirably employ the so-called three-spot method which is free of disturbances that employs main and auxiliary light beams for detecting a tracking error signal from the BD 100c with a smaller track pitch.

If the three-spot method is employed, then the optical pickup 6 is less subject to an offset that is caused between the radially inner and outer regions of the BD 100c by positioning the center S2 of the second objective lens 17 for playing the BD 100c on the line Lr.

There is known a single-spot method for detecting a tracking error signal using a single spot (light beam) rather than the three spots in the three-spot method. However, the single-spot method is liable to be affected by imperfections and dust particles on the recording surface of the disc-shaped recording medium 100. The three-spot method is less susceptible to such imperfections and dust particles on the recording surface of the disc-shaped recording medium 100.

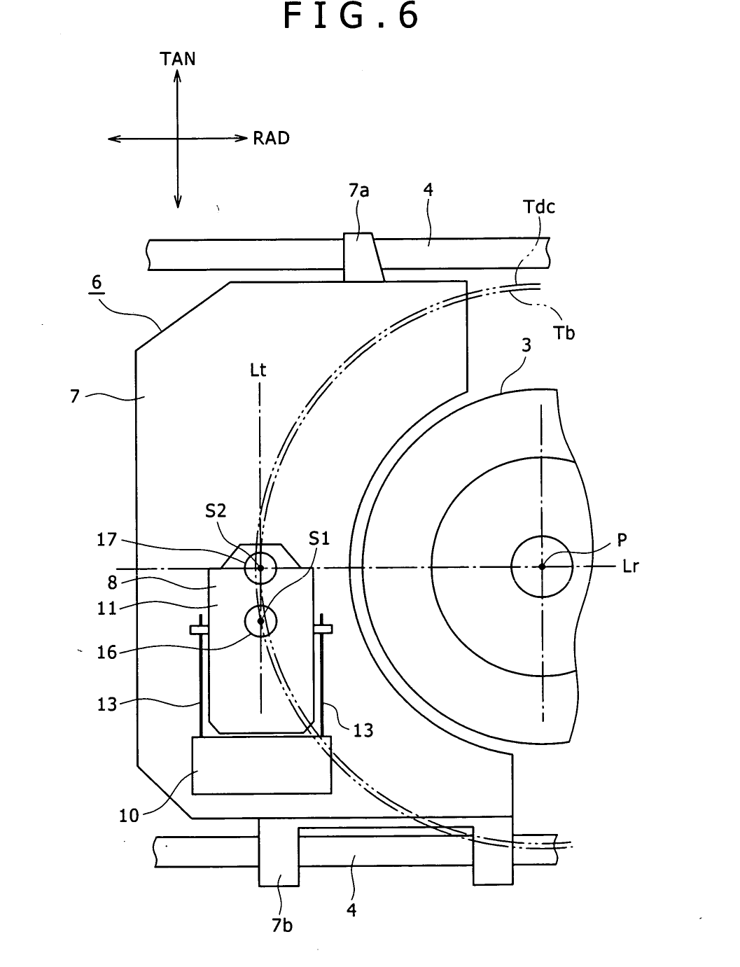

In the above embodiment, the first objective lens 16 for playing the DVD 100a and the CD 100b is disposed on the movable block 11 closer to its distal end, and the second objective lens 17 for playing the BD 100c is disposed on the movable block 11 closer to its proximal end, i.e., closer to the fixed block 10. Conversely, as shown in FIG. 6, the second objective lens 17 for playing the BD 100c may be disposed on the movable block 11 closer to its distal end, and the first objective lens 16 for playing the DVD 100a and the CD 100b may be disposed on the movable block 11 closer to its proximal end, i.e., closer to the fixed block 10.

With respect to the first objective lens 16 and the second objective lens 17, whether the objective lens layout shown in FIG. 4 or the objective lens layout shown in FIG. 6 should be employed may be determined in view of the ease with which to form the transmissive film of the separating surface 20a of the beam splitter 20. For example, if a transmissive film for reflecting laser beams having respective wavelengths of about 660 nm and 780 nm and for transmitting a laser beam having a wavelength of about 405 nm can easily be formed as the separating surface 20a, then the first objective lens 16 and the second objective lens 17 may be positioned successively in the order named from the distal end of the movable block 11. Conversely, if a transmissive film for reflecting a laser beam having a wavelength of about 405 nm and for transmitting laser beams having respective wavelengths of about 660 nm and 780 nm can easily be formed as the separating surface 20a, then the second objective lens 17 and the first objective lens 16 may be positioned successively in the order named from the distal end of the movable block 11.

In the above embodiments, the disc drive apparatus 1 for playing three types of the disc-shaped recording medium 100, i.e., the DVD 100a, the CD 100b, and the BD 100c, has been described. However, the principles of the present invention are also applicable to a disc drive apparatus for playing two types of the disc-shaped recording medium 100, i.e., the DVD 100a and the BD 100c, or a disc drive apparatus for playing two types of the disc-shaped recording medium 100, i.e., the CD 100b and the BD 100c.

In the above embodiments, the focusing directions have been described as vertical directions, and the tracking directions as transverse directions. However, these focusing and tracking directions have been illustrated by way of example only, and should not be limited to respectively to the vertical and transverse directions.

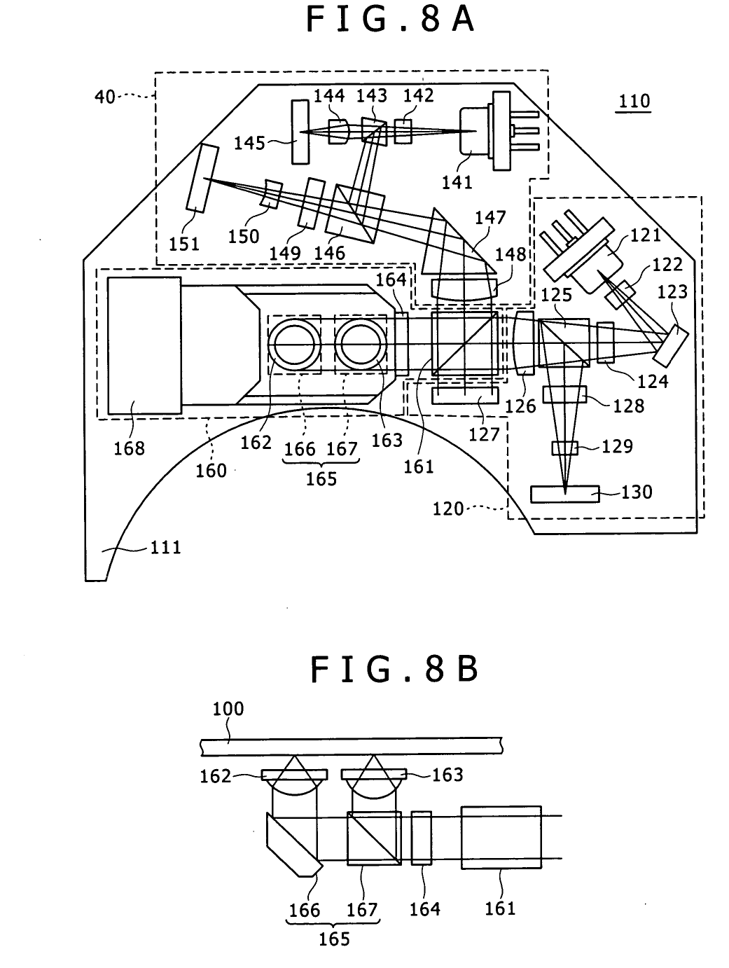

FIG. 8A shows a three-wavelength optical pickup 110 having various optical components mounted on a base 111. The optical pickup 110 has a CD/DVD optical system 120 for recording information on and reproducing information from CDs and DVDs, a BD optical system 140 for recording information on and reproducing information from BDs, and a common optical system 160 that is used commonly for CDs, DVDs, and BDs.

In the CD/DVD optical system 120, a laser beam emitted from a CD/DVD laser diode 121 as a first laser beam source is applied as a CD/DVD output beam successively through a coupling lens 122, a mirror 123, a grating 124, and a beam splitter 125 to a collimator lens 126. The collimator lens 126 converts the CD/DVD output beam into a parallel beam, and applies the parallel beam to the common optical system 160.

The common optical system 160 has a path-combining beam splitter 161 which reflects part of the CD/DVD output beam at a right angle to a front photodiode 127 which detects the laser power thereof. As described in detail below, the remainder of the CD/DVD output beam is applied from the path-combining beam splitter 161 through an CD/DVD objective lens 162 to the recording surface of an optical disc 100 (see FIG. 8B). A reflected beam from the optical disc 100 is travels through the CD/DVD objective lens 162 as a CD/DVD input beam back into the CD/DVD optical system 120.

In the CD/DVD optical system 120, the CD/DVD input beam is applied through the collimator lens 126 to the beam splitter 125. The beam splitter 125 reflects the CD/DVD input beam at a right angle. The reflected CD/DVD input beam is applied through a cylindrical lens 128 and a hologram 129 to a PDIC (Photo Detector IC) 130. The PDIC 130 converts the CD/DVD input beam into an electric signal, and outputs various signals including a reproduced signal, a tracking error signal, and a focusing error signal.

In the BD optical system 140, a laser beam emitted from a BD laser diode 141 as a second laser beam source is applied as a BD output beam to a polarizer 142 which includes a wavelength plate, a grating, or a combination thereof. The polarizer 142 rotates the plane of polarization of the BD output beam, and then applies the BD output beam to a beam splitter 143.

The beam splitter 143 passes part of the BD output beam therethrough. The BD output beam then travels through a collimator lens 144 to a front diode 145 which detects the laser power thereof. The beam splitter 143 reflects the remainder of the BD output beam, which is applied successively through a beam splitter 146 and a mirror 147 to a collimator lens 148. The collimator lens 148 converts the BD output beam into a parallel beam, which is applied to the common optical system 160.

In the common optical system 160, the path-combining beam splitter 161 reflects part of the BD output beam at a right angle. The reflected BD output beam is applied through a BD objective lens 163 to the recording surface of the optical disc 100. A reflected beam from the optical disc 100 is travels through the BD objective lens 163 as a BD input beam back into the BD optical system 140.

In the BD optical system 140, the BD input beam is applied through the collimator lens 148 and the mirror 147 to the beam splitter 146. The beam splitter 146 passes the BD input beam therethrough. The BD input beam is then applied through a hologram 149 and a coupling lens 150 to a PDIC 151. The PDIC 151 converts the BD input beam into an electric signal, and outputs various signals including a reproduced signal, a tracking error signal, and a focusing error signal.

Details of the common optical system 160 according to the present invention will be described below. In the common optical system 160, the CD/DVD objective lens 162 and the BD objective lens 163 are mounted on a common biaxial actuator 168. A mirror assembly 165 including an upwardly reflecting CD/DVD beam mirror 166 and an upwardly reflecting BD beam mirror 167 is disposed below the CD/DVD objective lens 162 and the BD objective lens 163.

As shown in FIG. 8B, the upwardly reflecting CD/DVD beam mirror 166 is disposed below the CD/DVD objective lens 162, and the upwardly reflecting BD beam mirror 167 is disposed below the BD objective lens 163. The path-combining beam splitter 161, the upwardly reflecting BD beam mirror 167, and the upwardly reflecting CD/DVD beam mirror 166 are positioned in line.

As described above, the CD/DVD output beam and the BD output beam are applied to the path-combining beam splitter 161, which serves as an optical path combiner, of the common optical system 160. The CD/DVD output beam and the BD output beam that have passed through the path-combining beam splitter 161 are applied through a liquid crystal device 164, which serves to correct spherical aberration, to the upwardly reflecting BD mirror 167, which serves as an optical path separator.

The upwardly reflecting BD mirror 167 includes a wavelength-selective beam splitter for reflecting only a blue-purple laser beam having a wavelength of 405 nm at a right angle. If a laser beam that is applied to the upwardly reflecting BD mirror 167 is the BD output beam, then the upwardly reflecting BD mirror 167 reflects the BD output beam upwardly, and the reflected BD output beam is applied through the BD objective lens 163 to the optical disc 100, i.e., a BD. A reflected beam from the BD passes through the BD objective lens 163, and is applied through the liquid crystal device 164 and the path-combining beam splitter 161 to the BD optical system 140.

If a laser beam that is applied to the upwardly reflecting BD mirror 167 is the CD/DVD output beam, then the upwardly reflecting BD mirror 167 passes the CD/DVD output beam to the upwardly reflecting CD/DVD mirror 166. The upwardly reflecting CD/DVD mirror 166 reflects the CD/DVD output beam upwardly, and the reflected CD/DVD output beam is applied through the CD/DVD objective lens 162 to the optical disc 100, i.e., a CD or a DVD. A reflected beam from the CD or the DVD passes through the CD/DVD objective lens 162, and is applied through the upwardly reflecting BD mirror 167, the liquid crystal device 164, and the path-combining beam splitter 161 to the CD/DVD optical system 120.

The CD/DVD objective lens 162 and the BD objective lens 163 are mounted on the common biaxial actuator 168. The CD/DVD output beam emitted from the CD/DVD optical system 120 and the BD output beam emitted from the BD optical system 140 are applied through the path-combining beam splitter 161 of the common optical system 160 to the upwardly reflecting mirror assembly 165. The upwardly reflecting BD mirror 167, which includes a wavelength-selective beam splitter, separates the CD/DVD output beam and the BD output beam from each other, and the CD/DVD output beam and the BD output beam are applied respectively through the corresponding objective lenses 162, 163 to the optical disc 100.

Since portions of the optical paths of the CD/DVD output beam and the BD output beam to be applied to the upwardly reflecting mirror assembly 165 are combined with each other by the path-combining beam splitter 161, the biaxial actuator 168 which holds the objective lenses 162, 163 has a common optical path for both the CD/DVD output beam and the BD output beam. Accordingly, the biaxial actuator 168 having a limited range in which the laser beams are applied thereto and also having a low profile can be incorporated in the three-wavelength optical pickup 110.

As described above, portions of the optical paths of the CD/DVD output beam and the BD output beam are combined with each other by the path-combining beam splitter 161, and the upwardly reflecting mirror assembly 165 separates the CD/DVD output beam and the BD output beam and applies them respectively to the corresponding objective lenses 162, 163. Therefore, the biaxial actuator 168 having a limited range in which the laser beams are applied thereto and also having a low profile can be incorporated in the three-wavelength optical pickup 110, making the three-wavelength optical pickup 110 low in profile. As a result, the optical disc drive 1 which is compatible with a plurality of wavelengths is rendered low in profile.

In the above embodiments, the two optical paths of the CD/DVD output beam and the BD output beam are combined with each other by the path-combining beam splitter 161. However, optical paths of CD, DVD, and BD output beams may be provided independently of each other, and may be combined by the path-combining beam splitter 161 and introduced into the upwardly reflecting mirror assembly 165. Optical discs that may be played by the optical disc drive 1 are not limited to CDs, DVDs, and BDs, but may include various other optical discs.

In the common optical system 160 shown in FIG. 8B, the CD/DVD objective lens 162 and the BD objective lens 163 may be switched around in position, with the upwardly reflecting CD/DVD beam mirror 166 disposed below the CD/DVD objective lens 162, and the upwardly reflecting BD beam mirror 167 below the BD objective lens 163. In this modification, the path-combining beam splitter 161, the upwardly reflecting BD beam mirror 167, and the upwardly reflecting CD/DVD beam mirror 166 may be arranged in line.

Specifically, the CD/DVD objective lens and the BD objective lens are positioned as shown in FIGS. 3 and 4, so that the CD/DVD output beam and the BD output beam that has passed through the path-combining beam splitter 161 will be applied to the upwardly reflecting CD/DVD beam mirror 166 serving as an optical path separator.

According to the modification, the upwardly reflecting CD/DVD beam mirror 166 includes a wavelength-selective beam splitter for passing a blue-purple laser beam having a wavelength of 405 nm. If a laser beam that is applied to the upwardly reflecting CD/DVD mirror 166 is the BD output beam, then the upwardly reflecting CD/DVD mirror 166 passes the BD output beam to the upwardly reflecting BD mirror 167. The upwardly reflecting BD mirror 167 reflects the BD output beam upwardly, and the reflected BD output beam is applied through the BD objective lens 163 to the optical disc 100, i.e., a BD. A reflected beam from the BD passes through the BD objective lens 163, and is applied through the upwardly reflecting BD mirror 167, the liquid crystal device 164, and the path-combining beam splitter 161 to the BD optical system 140.

If a laser beam that is applied to the upwardly reflecting CD/DVD mirror 166 is the CD/DVD output beam, then the upwardly reflecting CD/DVD mirror 166 reflects the CD/DVD output beam upwardly at a right angle. The reflected CD/DVD output beam is applied through the CD/DVD objective lens 162 to the optical disc 100, i.e., a CD or a DVD. A reflected beam from the CD or the DVD passes through the CD/DVD objective lens 162, and is applied through the upwardly reflecting CD/DVD mirror 166, the upwardly reflecting BD beam mirror 167, the liquid crystal device 164 and the path-combining beam splitter 161 to the CD/DVD optical system 120.

Although certain preferred embodiments of the present invention have been shown and described in detail, it should be understood that various changes and modifications may be made therein without departing from the scope of the appended claims.

What is claimed is:

1. An optical pickup for selectively applying at least two laser beams having respective wavelengths to one of at least two disc-shaped recording mediums of different types selectively mounted on a disc table, comprising:
a movable base movable radially across the disc-shaped recording mediums selectively mounted on the disc table; and
an objective lens actuator mounted on said movable base;
said objective lens actuator comprising:
a fixed block fixedly mounted on said movable base;
a movable block movable with respect to said fixed block in focusing directions toward and away from recording surfaces of the disc-shaped recording mediums and tracking directions which are substantially radial directions of the disc-shaped recording mediums;
a first objective lens mounted on said movable block for focusing a first laser beam onto the recording surface of one of the disc-shaped recording mediums; and
a second objective lens mounted on said movable block for focusing a second laser beam, which has a wavelength shorter than said first laser beam, onto the recording surface of another one of the disc-shaped recording mediums which is different in type from said one of the disc-shaped recording mediums;
said first objective lens and said second objective lens being spaced from each in a tangential direction of recording tracks on the disc-shaped recording mediums which is perpendicular to said focusing directions and said tracking directions;
said first or second objective lens having a center positioned on a line which passes through the center of the disc-shaped recording mediums selectively mounted on the disc table and which extends in the radial directions of the disc-shaped recording mediums;
said first objective lens having a center positioned on a line which passes through the center of said second objective lens and which extends in said tangential direction.

2. The optical pickup according to claim 1, further comprising:
a first laser beam source for emitting said first laser beam;
a second laser beam source for emitting said second laser beam;
a first optical path for guiding said first laser beam from said first laser beam source to said first objective lens;
a second optical path for guiding said second laser beam from said second laser beam source to said second objective lens;
an optical path combiner for combining portions of said first optical path and said second optical path; and
an optical path separator for separating the portions of said first optical path and said second optical path which have been combined by said optical path combiner, in front of said first objective lens and said second objective lens.

3. The optical pickup according to claim 2, wherein said optical path combiner combines the portions of said first optical path and said second optical path before said first laser beam and said second laser beam are introduced into said objective lens actuator.

4. The optical pickup according to claim 2, wherein said optical path separator is wavelength-selective, and separates the portions of said first optical path and said second optical path which have been combined by said optical path combiner, by separating said first laser beam and said second laser beam from each other depending on the wavelengths of the first laser beam and the second laser beam.

5. The disc drive apparatus for selectively playing at least two disc-shaped recording mediums of different types, comprising:
a disc table for selectively mounting the disc-shaped recording mediums thereon; and
an optical pickup for selectively applying at least two laser beams having respective wavelengths to one of the disc-shaped recording mediums selectively mounted on said disc table;
said optical pickup comprising:
a movable base movable radially across the disc-shaped recording mediums selectively mounted on the disc table; and
an objective lens actuator mounted on said movable base;
said objective lens actuator comprising:
a fixed block fixedly mounted on said movable base;
a movable block movable with respect to said fixed block in focusing directions toward and away from recording surfaces of the disc-shaped recording mediums and tracking directions which are substantially radial directions of the disc-shaped recording mediums;
a first objective lens mounted on said movable block for focusing a first laser beam onto the recording surface of one of the disc-shaped recording mediums; and
a second objective lens mounted on said movable block for focusing a second laser beam, which has a wavelength shorter than said first laser beam, onto the recording surface of another one of the disc-shaped recording mediums which is different in type from said one of the disc-shaped recording mediums;
said first objective lens and said second objective lens being spaced from each in a tangential direction of recording tracks on the disc-shaped recording mediums which is perpendicular to said focusing directions and said tracking directions;
said first or second objective lens having a center positioned on a line which passes through the center of the disc-shaped recording mediums selectively mounted on the disc table and which extends in the radial directions of the disc-shaped recording mediums;
said first objective lens having a center positioned on a line which passes through the center of said second objective lens and which extends in said tangential direction.

6. The disc drive apparatus according to claim 5, wherein said optical pickup further comprises:
a first laser beam source for emitting said first laser beam;
a second laser beam source for emitting said second laser beam;
a first optical path for guiding said first laser beam from said first laser beam source to said first objective lens;
a second optical path for guiding said second laser beam from said second laser beam source to said second objective lens;
an optical path combiner for combining portions of said first optical path and said second optical path; and
an optical path separator for separating the portions of said first optical path and said second optical path which have been combined by said optical path combiner, in front of said first objective lens and said second objective lens.
